(19) United States
(12) Patent Application Publication
(10) Pub. No.: US 2016/0100037 A1
(43) Pub. Date: Apr. 7, 2016

(54) ONLINE COLLABORATIVE SUITE

(71) Applicant: IE BUSINESS PLAINS, LLC, Riverside, CA (US)

(72) Inventors: Stephen B. VAN ZUTPHEN, Dali (CY); Makis HAVADJIAS, Riverside, CA (US)

(21) Appl. No.: 14/892,567

(22) PCT Filed: Aug. 15, 2013
(86) PCT No.: PCT/US13/55139

§ 371 Date: Nov. 19, 2015

Related U.S. Application Data
(60) Provisional application No. 61/683,353, filed on Aug. 15, 2012.
(60) Provisional application No. 61/719,305, filed on Oct. 26, 2012.
(60) Provisional application No. 61/719,806, filed on Oct. 29, 2012.

(51) Int. Cl. H04L 29/06; G06F 17/30; G06F 3/0488; H04L 12/58; G06F 9/44; G06F 3/0481; H04L 29/08; G06F 3/0482

(52) U.S. Cl. CPC H04L 67/42; H04L 67/1087; H04L 67/1012; H04L 67/1097; G06F 17/30076; G06F 3/0482; H04L 67/2804; H04L 51/046; G06F 9/4446; G06F 3/04817; G06F 3/0488

(57) ABSTRACT

A system and method for a system for server-side database-driven services that can be accessed by a variety of client side applications, as disclosed in this disclosure.

### FIELD OF THE INVENTION

The present invention relates to Internet services, more specifically to a system for server-side database-driven services that can be accessed by a variety of client side applications.

### BACKGROUND

There are many applications for desktop computers and mobile devices for accessing a variety of content, such as, for example, e-mail, documents and contacts. However, these applications all work individually and not collaboratively. While there is some compatibility and interaction amongst the various applications that a user may load onto either their desktop or mobile device, there is no consistency for data transfer between them.

Therefore there is a need a system for server-side database-driven services that can be accessed by a variety of client side applications.

### SUMMARY

The invention is a system for server-side database-driven services that can be accessed by a variety of client side applications. The system comprises at least one proxy server, which has at least one load balancer and at least one web server communicatively coupled to the proxy server. The web server has at least one application server communicatively coupled to the web server. The application server has at least one database server and at least one network aware file system communicatively coupled to the application server. The proxy server, web server, application server, database server and network aware file system comprise a private cloud computing space for a user.

Optionally, there can be at least one network aware file system communicatively coupled to the application server, where the proxy server, web server, application server, database server and network aware file system comprise a private cloud computing space for a user.

Optionally, the database server can comprise a single integrated database with pre-defined links. The invention can further comprise one or more data servers. The data servers can comprise a file server, a streaming multimedia server, an application server or server cluster, a mail server and a chat server.

Additionally, there is a user interface for accessing the interoperable client side applications which are communicatively coupled to the application server, and the server-side database-driven service module accessible by the interoperable client side applications which are communicatively coupled to the database server. The user can switch between the client side applications without having to stop and start other client side applications. The interoperable client side applications can comprise a movies application, a calendar application, a document application, an e-mail application, a video application and a contacts application.

Optionally, the user interface can comprise a touch interface. The user interface can be accessed by specific motions to quickly access the system. The specific motions can comprise an up swipe, a right swipe, a left swipe and a downward swipe. The up swipe motion accesses a communications client side application, the right swipe accesses a file client side application, the left swipe accesses an events client side application, and the downward swipe accesses a contacts client side application.

Optionally, the user interface can further comprise a help icon, where the help icon activates instructions for a client side application to access all contextually associated related data to an open client side application.

The database-driven service module can be accessed through the user interface that ties all the client side applications together. The user interface comprises instructions operable on the application server to provide an automatic contextual basis for accessing content.

The invention also comprises a method for using server-side database-driven services that can be accessed by a variety of client side applications. The method comprises the steps of providing the system for server-side database-driven services that can be accessed by a variety of client side applications, displaying a user interface, accessing a user profile, determining a user motion to access the interoperable client side applications, receiving at least one request from the interoperable client side applications, executing instructions in the system corresponding to the received request from the user motion and the user profile, accessing contextual data related to the received request and the user profile, transmitting the contextual data to the interoperable client side applications, and storing in a database relations between the contextual data transmitted and the interoperable client side applications and the user profile.

Additionally, the contextual data can comprise personal information, a document, a file, an e-mail and a calendar event. The interoperable client side applications can display additional options where the user can add selected contextually related documents and files in the interoperable client side applications.

The invention also comprises a method for using server-side database-driven services that can be accessed by a variety of client side applications. The method comprises the steps of accessing a user profile, receiving requests from a plurality of client side applications, determining a user traffic load over the database server, balancing the user traffic load over the database server and the application server, determining if additional application and database servers need to be dynamically added if the load of all the servers increases to a point that would impede the use of the system, transmitting the requested data to the client side application, and storing relations between the transmitted data and the user profile.

### BRIEF DESCRIPTION OF THE DRAWINGS

These and other features, aspects and advantages of the present invention will become better understood with regard to the following description, appended claims, and accompanying figures where:

FIG. 1 is a diagram of a typical user's daily activity;

FIG. 2 is a is a diagram of a system for server-side database-driven services that can be accessed by a variety of client side applications;

FIG. 3 is a diagram depicting user motions to quickly access the system of FIG. 1 according to one embodiment;

FIG. 4 is a functional diagram of a tablet device displaying an interface of the system of FIG. 1 according to one embodiment;

FIG. 5 is a functional diagram of the tablet of FIG. 4 showing a user motion to access the scheduling subsystem of FIG. 2;

FIG. 6 is a functional diagram of a user motion for docking an event using the system of FIG. 2;

FIG. 7 is a functional diagram user motion returning to the main screen of the system of FIG. 2;

FIG. 8 is a functional diagram of a user motion for accessing the messaging subsystem from the main screen of the system of FIG. 2;

FIG. 9 is a functional diagram of a user motion for docking an e-mail using the system of FIG. 2;

FIG. 10 is a functional diagram of a user motion for returning to the main interface using the system of FIG. 2;

FIG. 11 is a functional diagram of a user motion for accessing the document subsystem of the system of FIG. 2;

FIG. 12 is a functional diagram of a user motion for docking using the document subsystem of the system of FIG. 2;

FIG. 13 is a functional diagram of a user motion for accessing all the docked material from the different subsystems of the system of FIG. 2;

FIG. 14 is a functional diagram of a user motion for adding an event to a contact using the docked material from the different subsystems of the system of FIG. 2;

FIG. 15 is a functional diagram of a user motion for docking both a message and a document to a contact from the docked material from the different subsystems of the system of FIG. 2;

FIG. 16 is a functional diagram of a confirmation displayed that both the message and the documents were successfully sent to the contact from FIG. 15;

FIG. 17 is a flowchart diagram of an ERD scheme for a server-side subsystem of the system of FIG. 2, according to one embodiment;

FIG. 18 is a structural diagram of the server-side subsystem of the system of FIG. 2;

FIG. 19 is an enterprise diagram of the server-side subsystem of the system of FIG. 2;

FIG. 20 is a chart of typical usage profiles of the server-side subsystem of the system of FIG. 2;

FIG. 21 is a screenshot of a client-side subsystem for accessing the server-side subsystem of the system of FIG. 2;

FIG. 22 are charts of a plurality of application servers central processing unit loads while operating the server-side subsystem of the system of FIG. 2;

FIG. 23 are charts of a plurality of database server loads while operating the server-side subsystem of the system of FIG. 2;

FIG. 24 is a chart of network usage bandwidth for a non-master database server of the system of FIG. 2;

FIG. 25 is a chart of network usage bandwidth for an application server of the system of FIG. 2;

FIG. 26 is a workflow diagram of a mobile device where the content of the device is automatically updated contextually using the system of FIG. 2;

FIG. 27 is a search interface for accessing the content of the mobile device using the system of FIG. 2, according to one embodiment;

FIG. 28 is a diagram of a contextual browser interface for the mobile device using the system of FIG. 2;

FIG. 29 is a is a screenshot of a selected content from the contextual browser interface of FIG. 28;

FIG. 30 is a zoomed screenshot of a selected contact from the contextual browser interface of FIG. 28;

FIG. 31 is a diagram of a user motion for accessing content related to the selected contact from the contextual browser interface of FIG. 28;

FIG. 32 is a diagram of a user motion for zooming on the content accessed in FIG. 31;

FIG. 33 is a diagram of content that is contextually related to the content accessed in FIG. 32;

FIG. 34 is a diagram of a user motion for accessing related content to the content accessed in FIG. 33;

FIG. 35 is a diagram of the user motion for displaying the content accessed in FIG. 34;

FIG. 36 is an enlarged view of the displayed content of FIG. 35;

FIG. 37 is a diagram of a user motion for enlarging the displayed content of FIG. 36; and

FIG. 38 is a diagram of a user motion for accessing all the information related to the area that the user selected with the user motion.

### DETAILED DESCRIPTION

The present invention overcomes the limitations of the prior art by providing a system for server-side database-driven services that can be accessed by a variety of client side applications. As can be appreciated, currently available portable consumer electronic devices available today are more akin to computers than to simple, single function devices previously available. These devices are capable of storing, recalling, transmitting, receiving and displaying a vast array of file types. These devices are also capable of running multiple applications at the same time. However, as the complexity of the devices increase, so to, does the amount of interaction that is needed by the user to operate these devices. For example, a Apple® iPad camera variety of applications, however, most of these applications cannot communicate with one another. Also, the user must always switch between applications in order to access a variety of content, limiting the functionality to the user. Also, for example, an Apple® iPhone® is capable of displaying sales presentations with the appropriate hardware and software attachments making it a good solution for portable sales. However, the user must always have the exact content for the iPhone® in their device to move between slides or other documents. The present invention provides a system for server-side database-driven services that can be accessed by a variety of client side applications without changing the applications the user uses.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “portable electronic device” refers to any current or future electronic device such as a smartphone, a table, an eBook reader or the like that communicates and displays information to one or more than one user.

The term “interoperable client side application” refers to applications that can transfer or access data from other applications.

The term “cloud computing space” refers to a distributed computing environment over a network with the capability to run a program on many connected computers at the same time.

Various embodiments provide a system for server-side database-driven services that can be accessed by a variety of client side applications. In another embodiment, there is provided a method for using the system. The system and method will now be disclosed in detail.

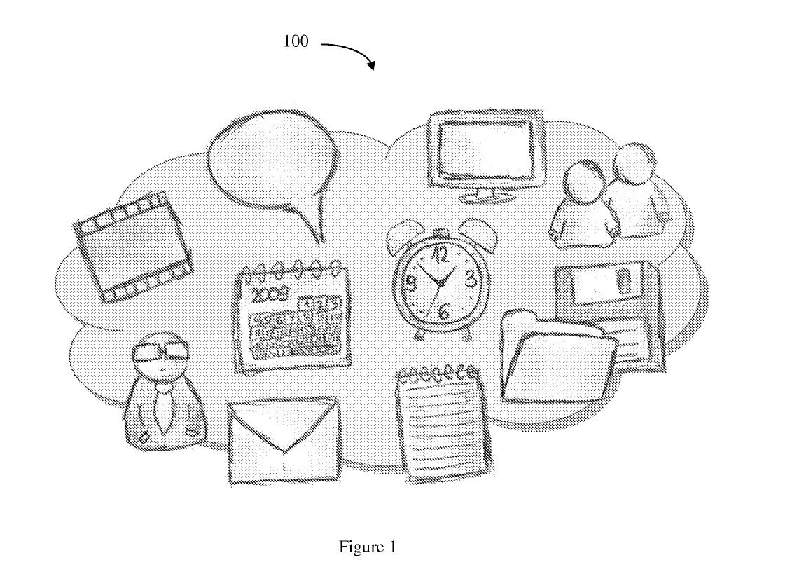

Referring now to FIG. 1, there is shown a diagram 100 of a typical user's daily activity. As can be seen in the diagram, a typical user accesses movies, calendars, documents, e-mails, videos, and contacts our regular basis. Prior art devices only allow for limited interaction between disparate applications requiring the user to switch between applications or even to stop and start applications. Depending upon the device.

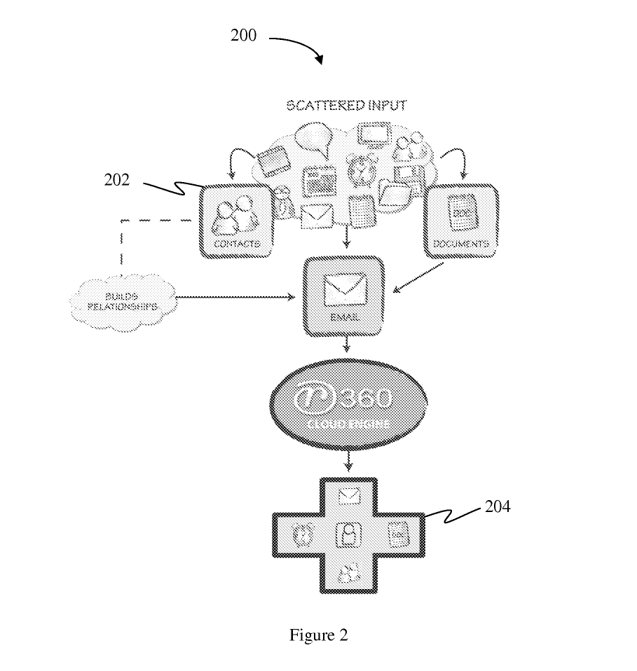

Referring now to FIG. 2, there is shown a diagram 200 of a system for server-side database-driven services 202 that can be accessed by a variety of client side applications 204. As can be seen, the system 200 described herein provides an automatic contextual basis for accessing the variety of content the user normally accesses with a single, easy-to-use interface that ties all the applications together 204.

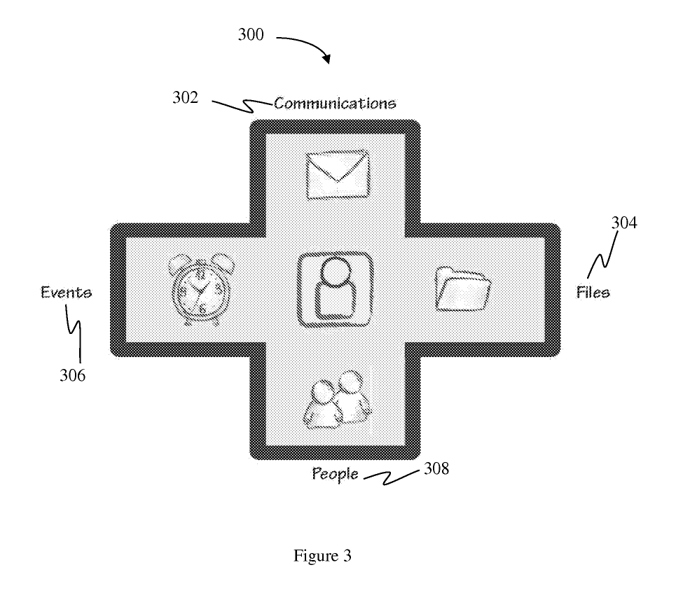

Referring now to FIG. 3, there is shown a diagram depicting user motions 300 to quickly access the system 200, according to one embodiment. In this embodiment, communications 302 use an up swipe, file access 304 uses a right swipe, events 306 use a left swipe, and people or contacts 308 use a downward swipe. Although presented in this manner, it will be understood by those with skill in the art that there are many other embodiments and styles motion that can be used.

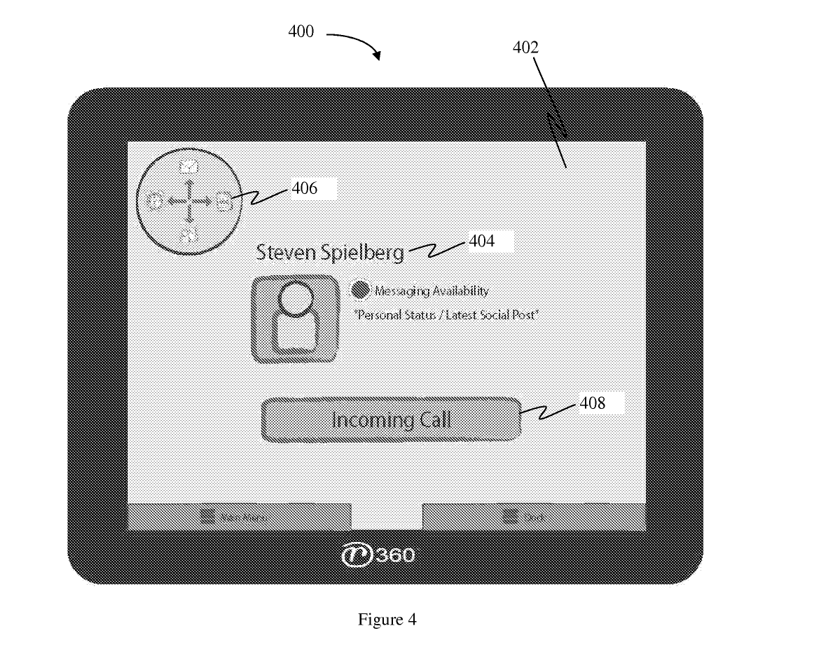

Referring now to FIG. 4, there is shown a functional diagram 400 of a tablet device displaying an interface 402 of the system 100 according to one embodiment. As an example, a user receives an incoming call 406 from a contact 404 on their contact list. A help icon 406 in the upper left-hand corner of the device where the applications reside so that the user can access data that is contextually related to the person 404 calling 408 and all the data associated with that person.

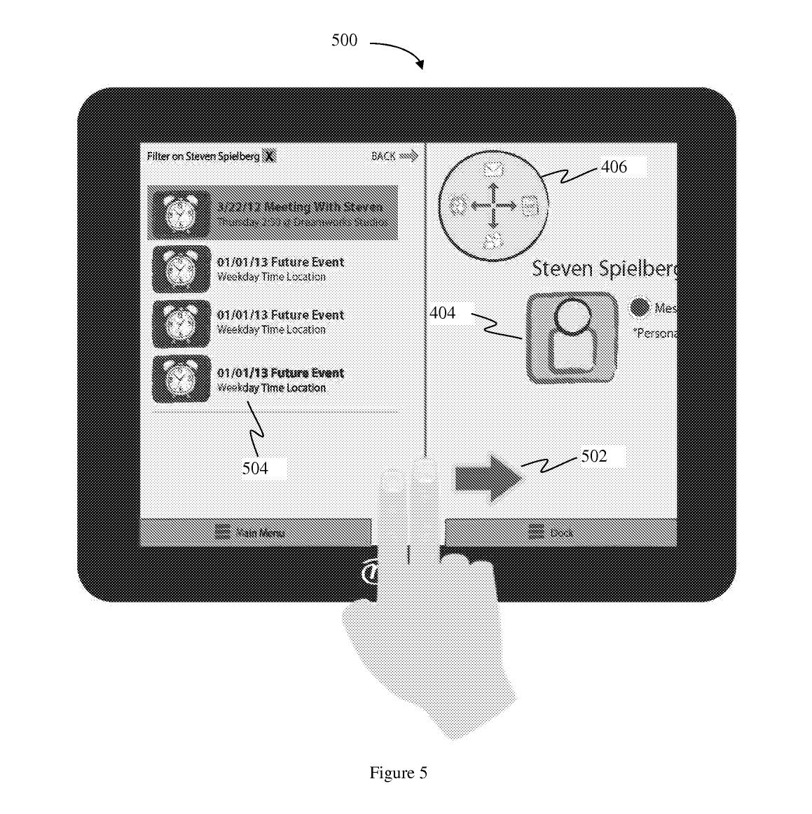

Referring now to FIG. 5, there is shown a functional diagram 500 of the tablet 400 showing a user motion 502 to access a scheduling subsystem 504 of the system 200. For example, by making it left swiping motion 502, the user can add an event to the phone call 408 that was just received.

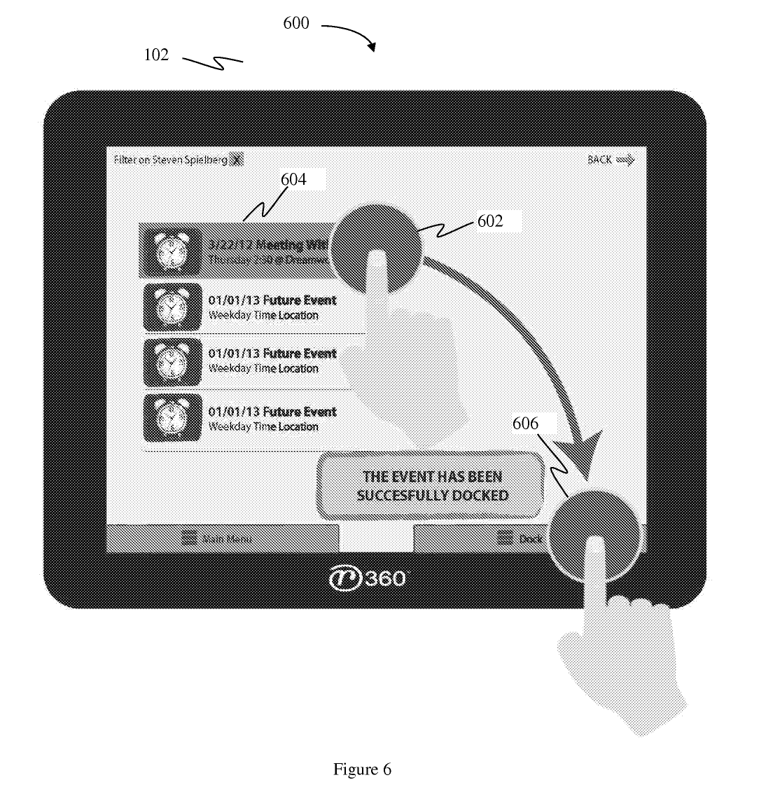

Referring now to FIG. 6, there is shown a functional diagram 600 of a user motion 602 for docking an event using the system 200. Once the user has selected the type of event 604 to be added to the received phone call 408, the user simply drags and drops the event 604 onto a section of the interface known as the dock 606. Once the user has docked 606, the event 604 is now associated contextually with the phone call 408 and the person 404 who called.

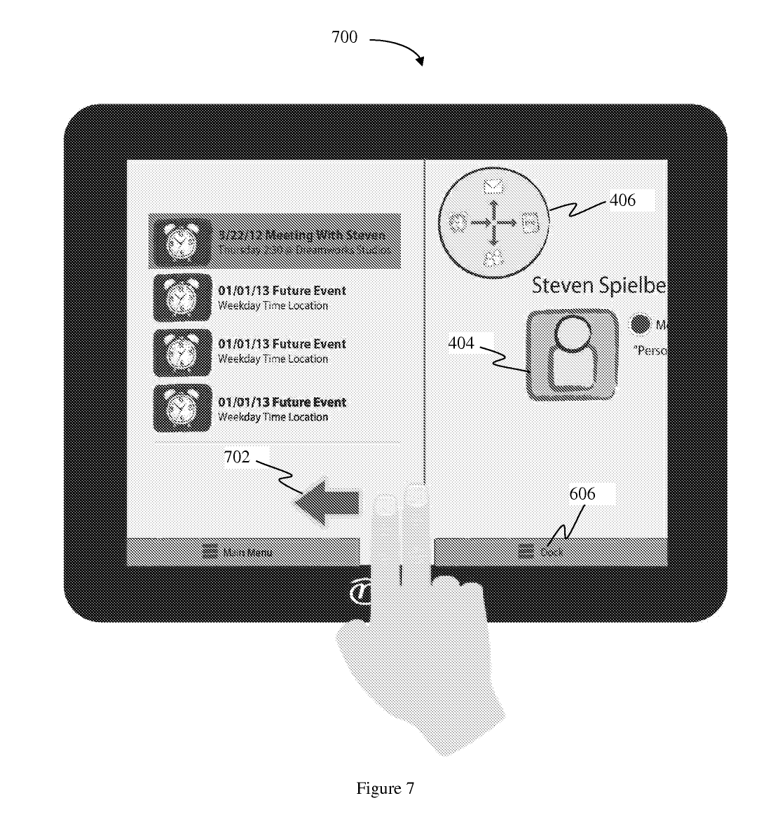

Referring now to FIG. 7, there is shown a functional diagram 700 of a user motion 702 returning to the main screen 402 of the system 200. As can be seen, the user can then return to the home screen 402 by making a right swiping motion 702.

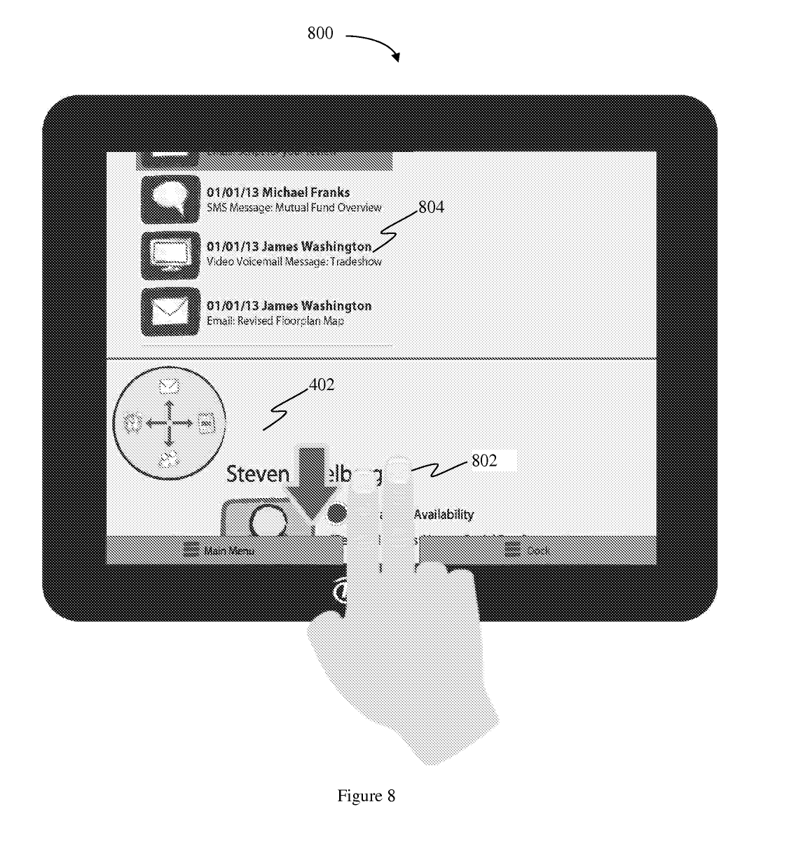

Referring now to FIG. 8, there is shown a functional diagram 800 of a user motion 802 for accessing a messaging subsystem 804 from the main screen 402 of the system 200. Next, the user can access the person's contact 404 information by making a downward swipe 802 as shown.

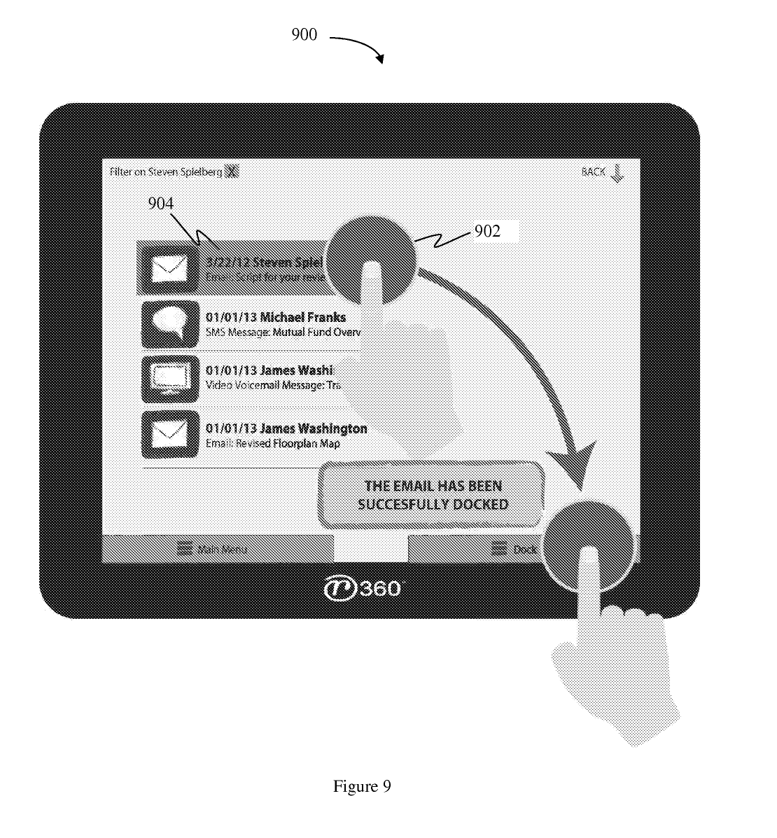

Referring now to FIG. 9, there is shown a functional diagram 900 of a user motion 902 for docking 606 an e-mail 904 using the system 200. Again, the user can associate content contextually related to the contact 404, in this case an e-mail, and dock 606 that information to the phone call 408 and the person 404.

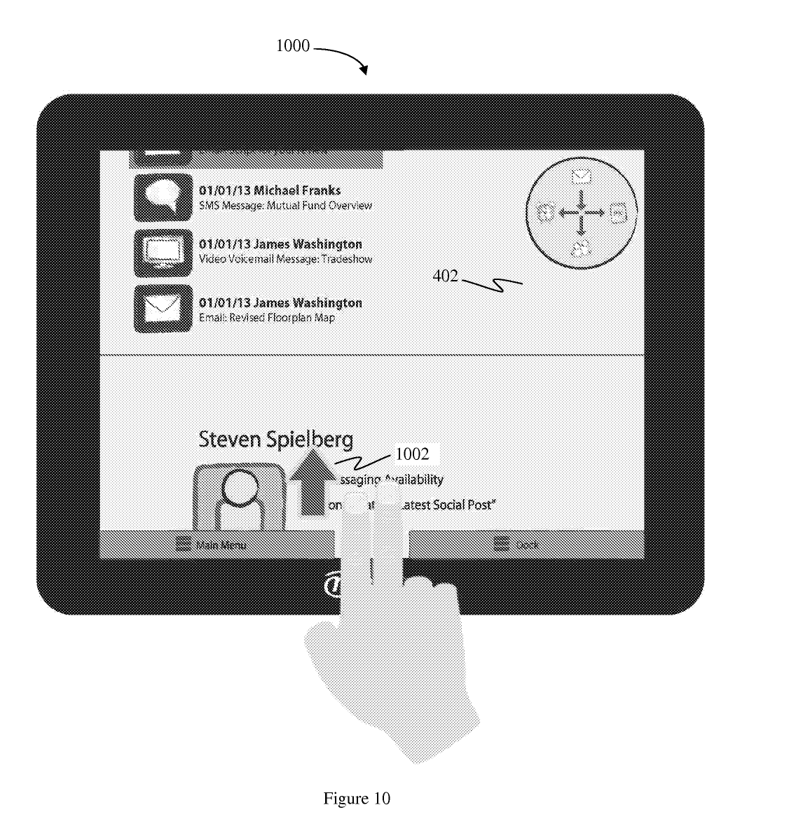

Referring now to FIG. 10, there is shown a functional diagram 1000 of a user motion 1002 for returning to the main interface 402 using the system 200. The user can then return to the home menu 402 by making an upward swiping motion 1002.

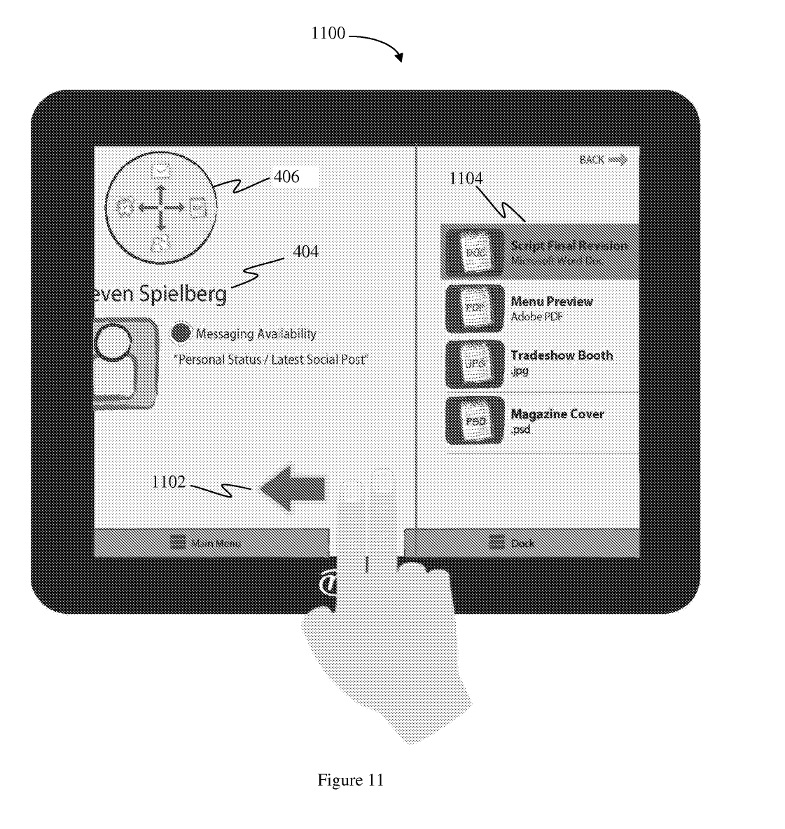

Referring now to FIG. 11, there is shown a functional diagram 1100 of a user motion 1102 for accessing a document subsystem 1104 of the system 200. From here, the user can access the content associated contextually with the person 404 on the main screen 402 and dock 606 that information so it is associated with the person 404. The user can make a left swiping motion 1102 to access the document subsystem 1104 that comprises content in the form of documents, images, movies, or any other type of file that can be opened in a separate program.

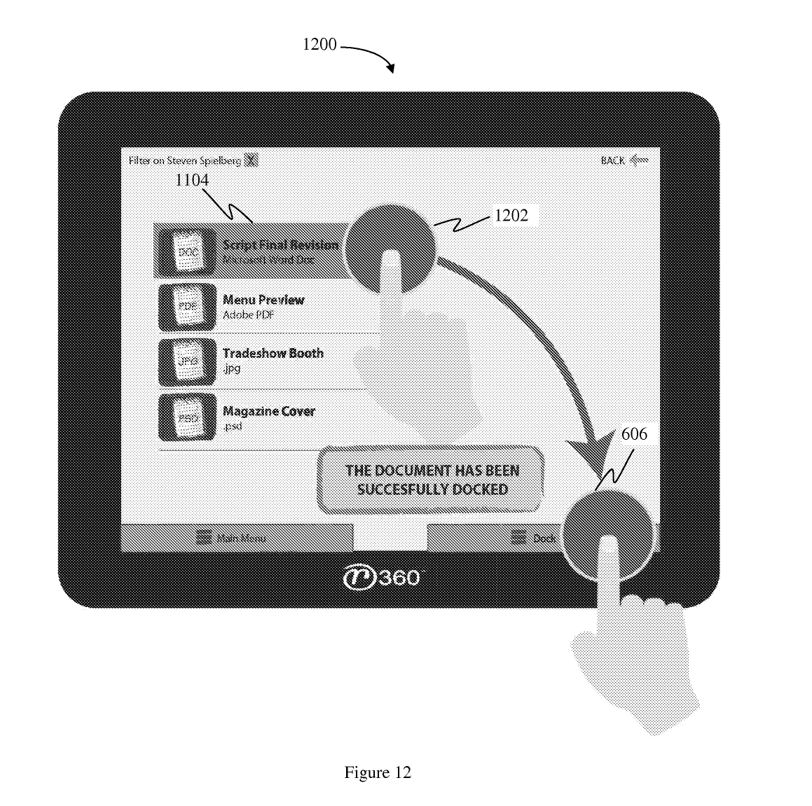

Referring now to FIG. 12, there is shown a functional diagram 1200 of a user motion 1202 for docking 606 content from the document subsystem 1104 using the system 200. The user can then dock 606 information related to the person 404 making the incoming call 408 by placing one or more documents from the document subsystem 1104 in the dock 606.

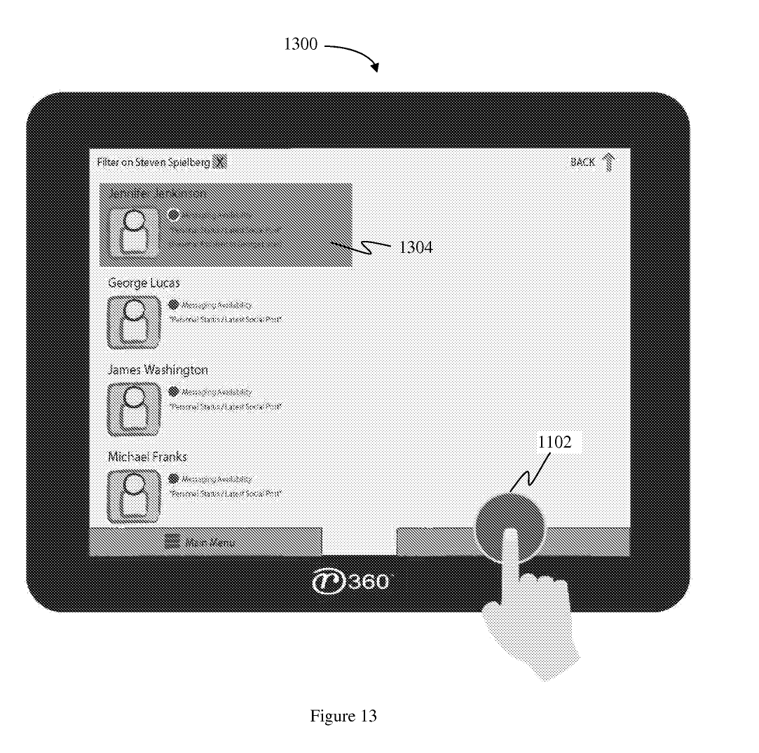

Referring now to FIG. 13, there is shown a functional diagram 1300 of a user motion 1302 for accessing all the docked 606 material from the different subsystems of the system 200. Optionally, the user can tap on an area of the screen and see other contacts 1304 the related to the person 404 who made the incoming call 408. These other contacts 1304 can also be associated with all the documents, files, e-mails and calendaring events that the user had previously selected for the person 404 making the incoming call 408.

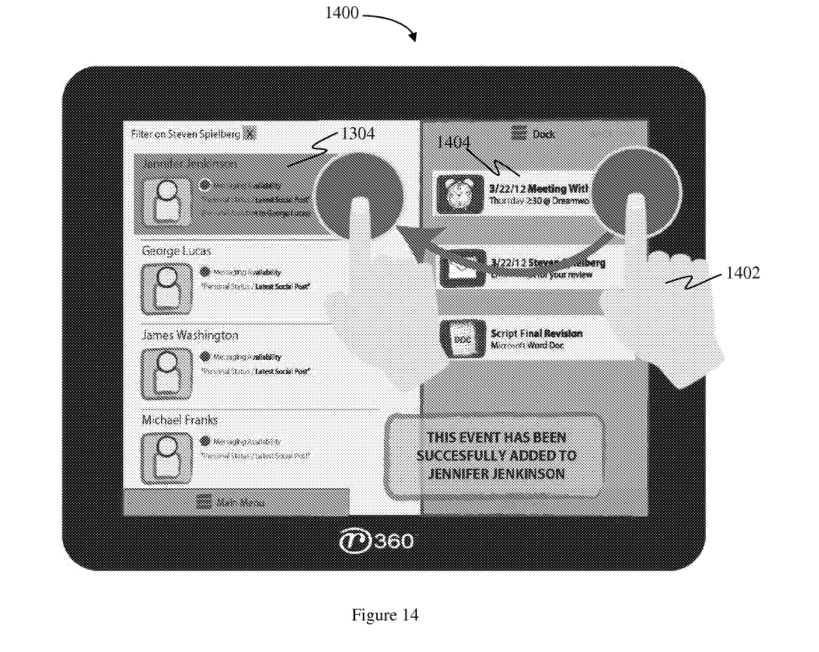

Referring now to FIG. 14, there is shown a functional diagram 1400 of a user motion 1402 for adding an event 1404 to a contact 1304 using the docked material 606 from the different subsystems of the system 200. As can be seen, the user can form a motion to tap, drag and drop an event 1402 to other contacts 1304 related to the person 404 making the incoming call 408. In this manner, events, documents and other related material can be quickly and easily added to all members of the team or disparate contacts that are related to the contact currently being accessed.

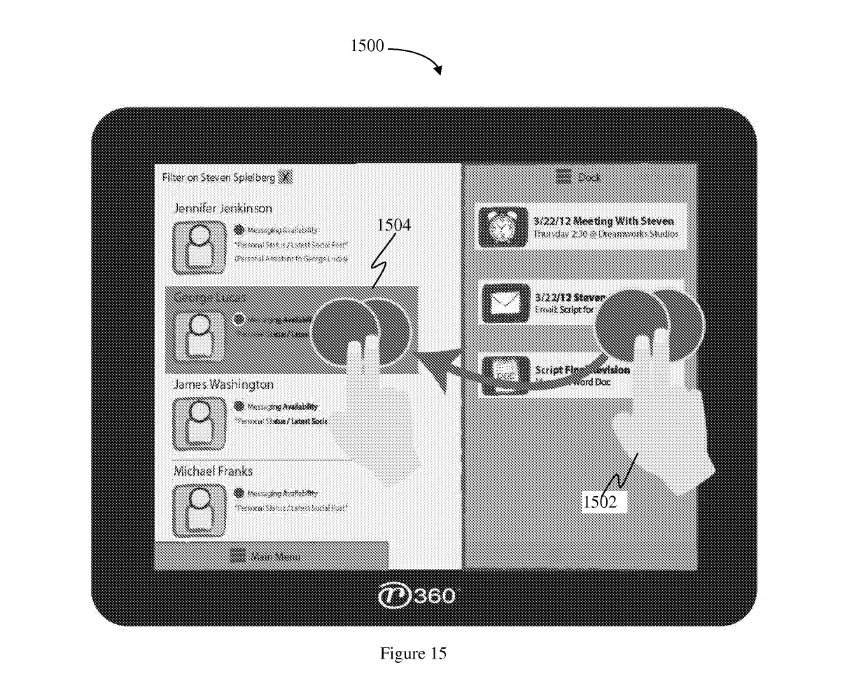

Referring now to FIG. 15, there is shown a functional diagram 1500 of a user motion 1502 for docking 606 both a message and a document to a contact 1504 from the docked material 606 from the different subsystems of the system 200. In this diagram 1500, there is shown a user motion 1502 for accessing multiple documents, e-mails or other files and sending them or associating them with another contact 1504 is related to the contacts 404 currently being accessed by the user. Once the user has docked the files to the contact 1504, but is different than the contact 404 being accessed, the system automatically performs preset functions related to the documents, such as sending an e-mail attaching the files, etc., without requiring the user to switch to another application to manually attach the files and send e-mail. This results in a great time-saving and increased efficiency for users.

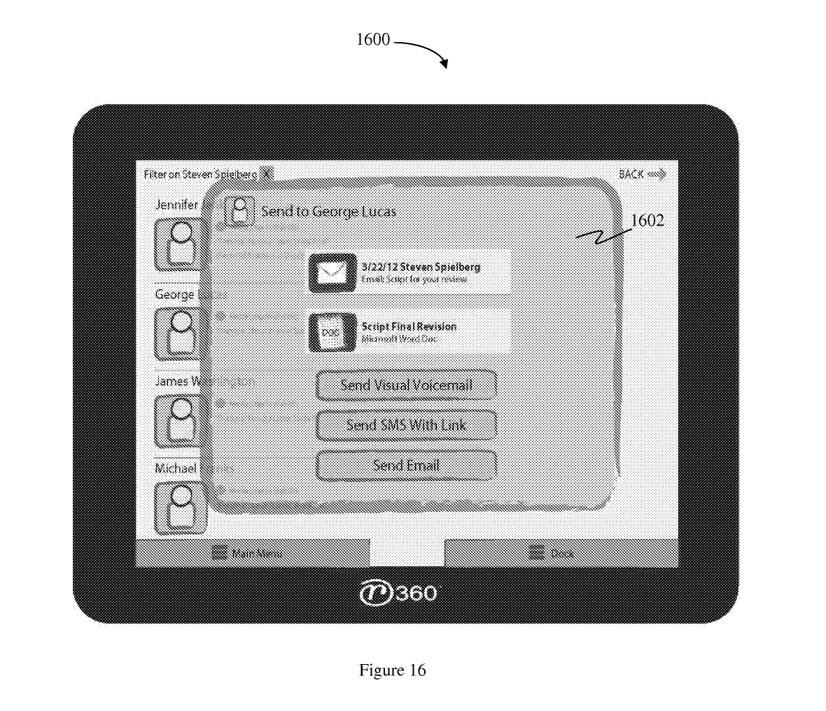

Referring now to FIG. 16, there is shown a functional diagram 1600 of a confirmation dialog 1602 displayed on the system 200 informing the user that both the message and the documents were successfully sent to the contact 1504. Once the system 200 has completed the actions associated with the documents, a dialog 1602 appears confirming that the message, or other action, has been completed. Optionally, there are also displayed additional options that the user can access with the documents and files already selected and the contact currently accessed.

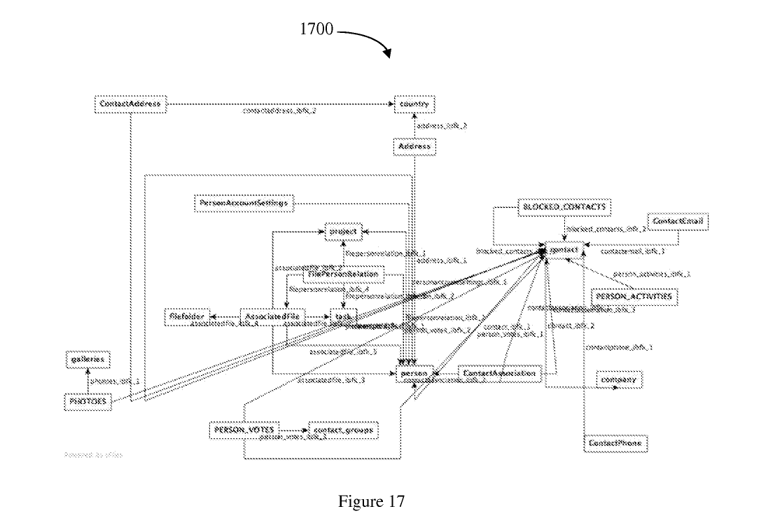

Referring now to FIG. 17, there is shown a flowchart diagram of an ERD database scheme 1700 for a server-side subsystem of the system 200, according to one embodiment. The core database 1700 comprises a single integrated database with pre-defined links. In this embodiment, the database 170 comprises 120 tables and 1008 columns of pre-defined links and contextually relatable fileds. The database 1700 is designed to work with most mobile devices, such as, for example, smart phones and tablets. A more detailed field listing is attached as Appendix A which is hereby incorporated by reference in its entirety.

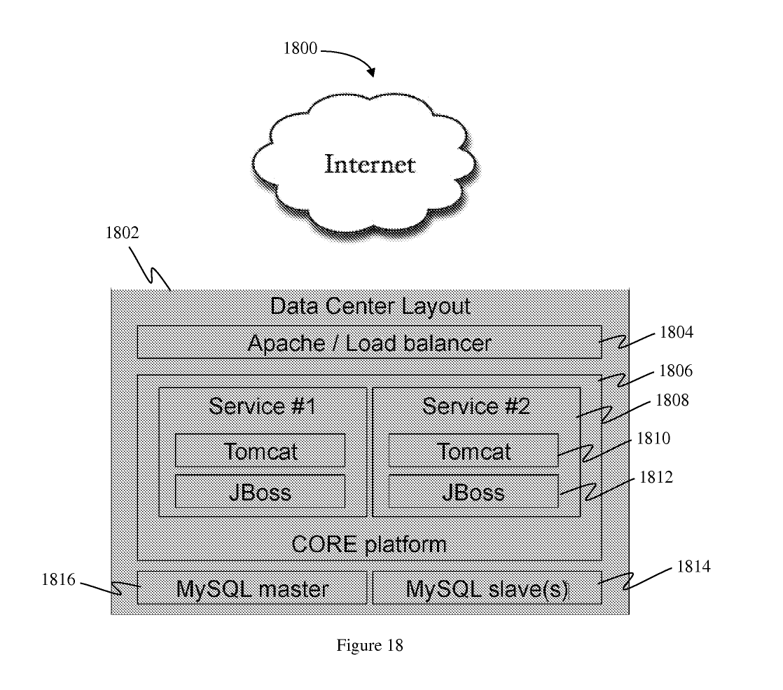

Referring now to FIG. 18, there is shown a structural diagram 1800 of the server-side subsystem of the system 200. As can be seen in this embodiment, the server 1800 comprises a load balancer 1804, one or more than one database servers 1814, one or more than one instance of JBoss application servers 1812 for serving the core applications 1806 to the user. In this embodiment, the database server 1814 are MySQL® servers comprising at least one master 1816 and one or more than slave databases 1814.

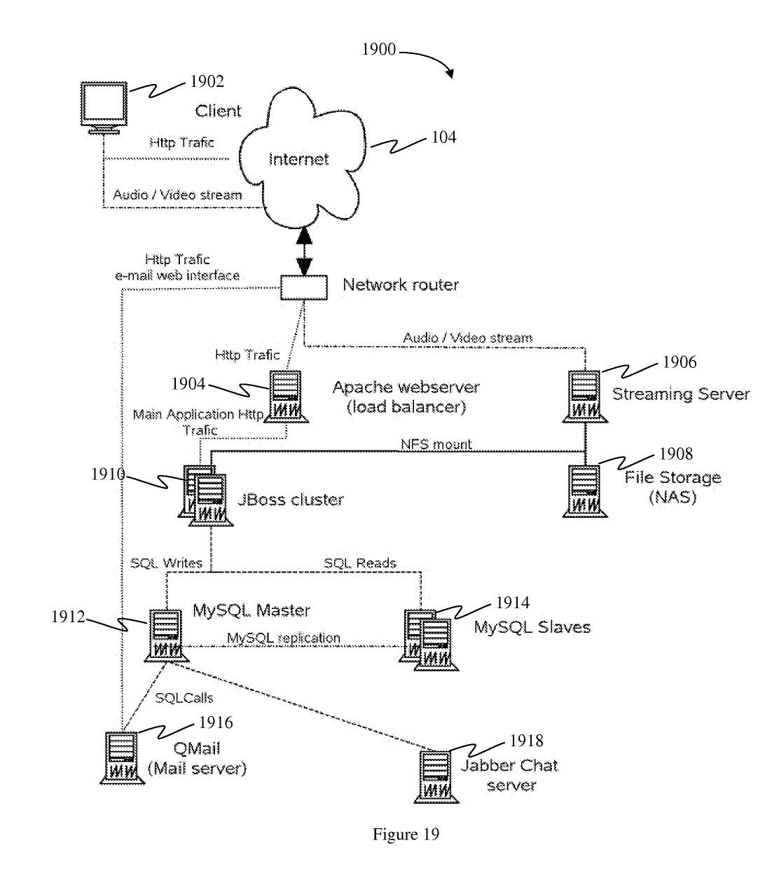

Referring now to FIG. 19, there is shown an enterprise diagram 1900 of the server-side subsystem of the system 200. In this example, the user 1902 requests information from the core server 1904. Then, the request goes to the appropriate data server 1906, 1908 and 1910 as determined by the server-side subsystem 1800. The data servers 1906, 1908 and 1910 can comprise a file server 1908, a streaming multimedia server 1906, an application server 1910 or server cluster 1912 and 1914, a mail server 1916 and a chat server 1918.

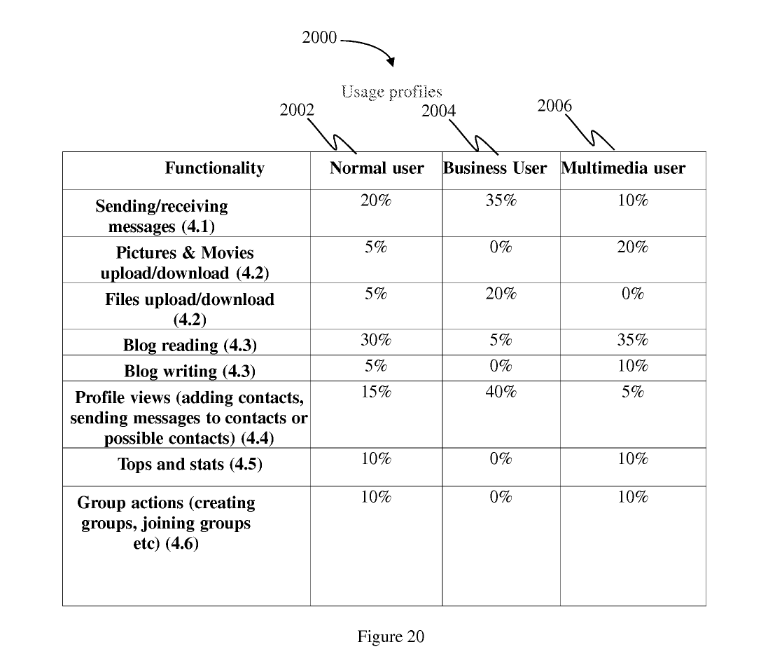

Referring now to FIG. 20, there is shown a chart of typical usage profiles 2000 of the server-side subsystem of the system of FIG. 2. This chart represents a current typical breakdown of traffic on the system according to the type of user 2002, 2004 and 2006. As can be appreciated, business users 2004 comprise the majority of the messaging and profile traffic. Therefore, more resource would be allocated to business users 2004 during operating hours and can be dynamically allocated during off peak hours.

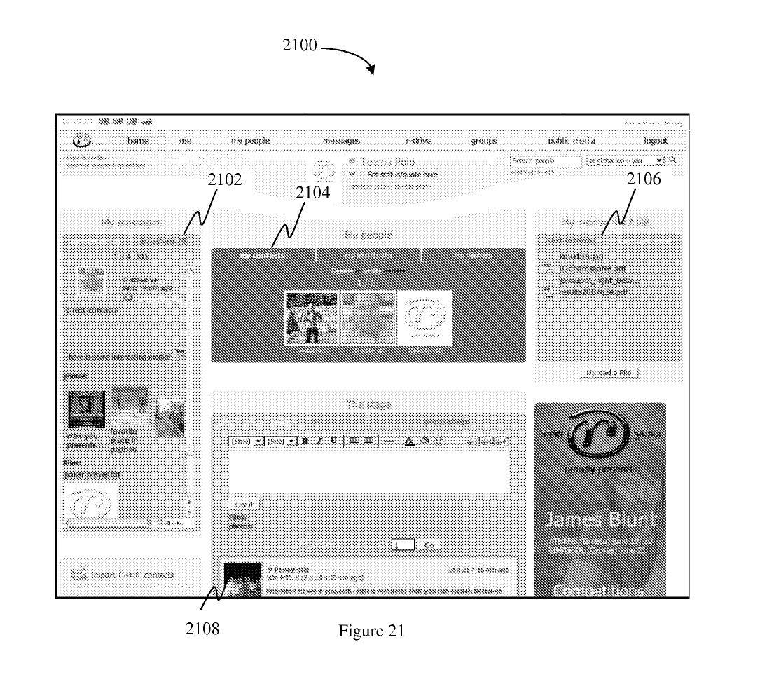

Referring now to FIG. 21, there is shown a screenshot 2100 of a client-side subsystem for accessing the server-side subsystem of the system 200. As can be seen in this embodiment, the user can use many different applications 2102, 2104, 2106 and 2108 simultaneously using the system 200. Each application 2102, 2104, 2106 and 2108 appears to be independent from one another, but are in fact tied to a user's profile and the information stored in the system 200.

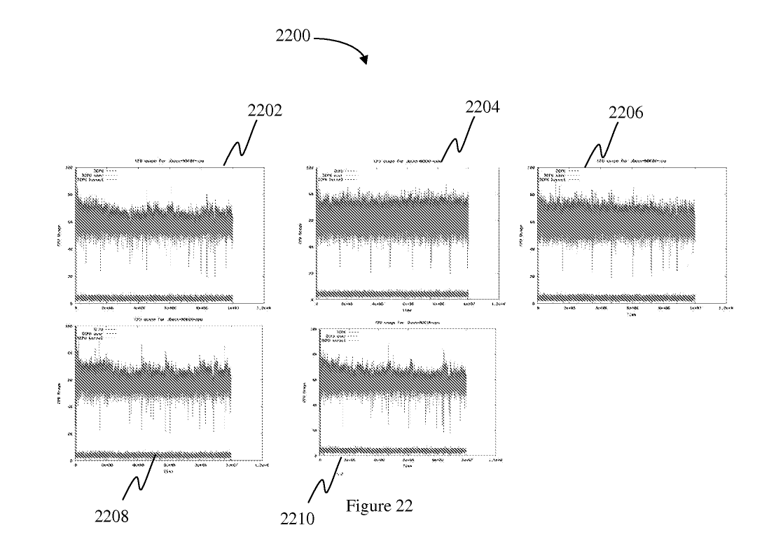

Referring now to FIG. 22, there are shown charts of a plurality of application servers central processing unit loads 2200 while operating the server-side subsystem of the system 200. Using the architecture described above, the server-side application servers can maintain a moderate amount of usage 2202, 2204, 2206, 2208 and 2210. Other application servers can be added dynamically if the load of all the servers 2202, 2204, 2206, 2208 and 2210 increases to a point that would impede the use of the system 200.

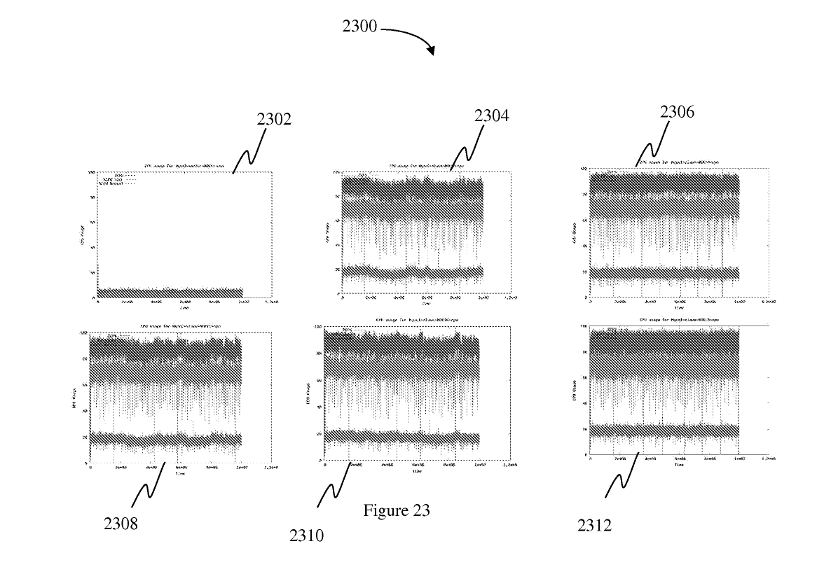

Referring now to FIG. 23, there are shown charts of a plurality of database server loads 2300 while operating the server-side subsystem of the system 200. As can be seen, the master database server 2302 has the least amount of operations. The slave databases 2304, 2306, 2308, 2310 and 2312 have the largest loads while serving data to users of the system 200.

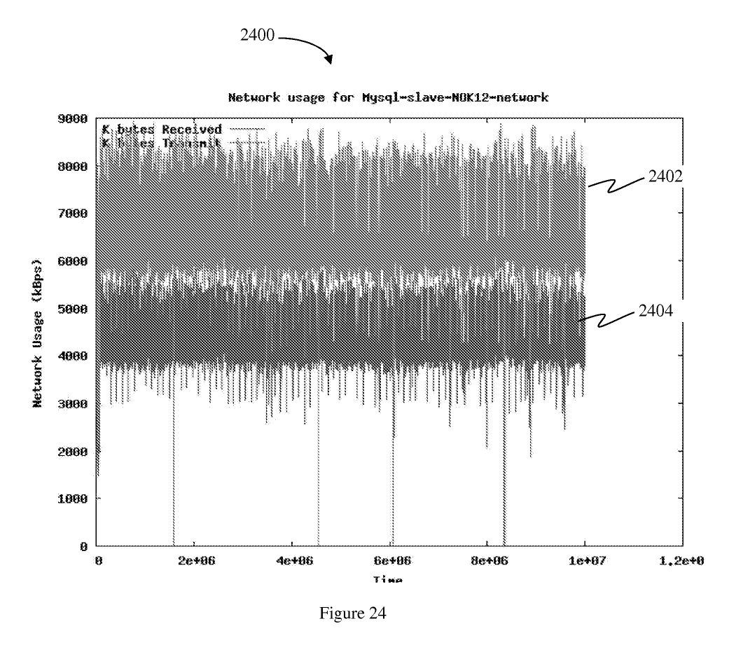

Referring now to FIG. 24, there is shown a chart of network usage bandwidth 2400 for a non-master database server of the system 200. This diagram shows the relation of the network traffic between the master and slave database servers. As can be appreciated, the amount of data transmitted 2402 is larger than the received requests 2404.

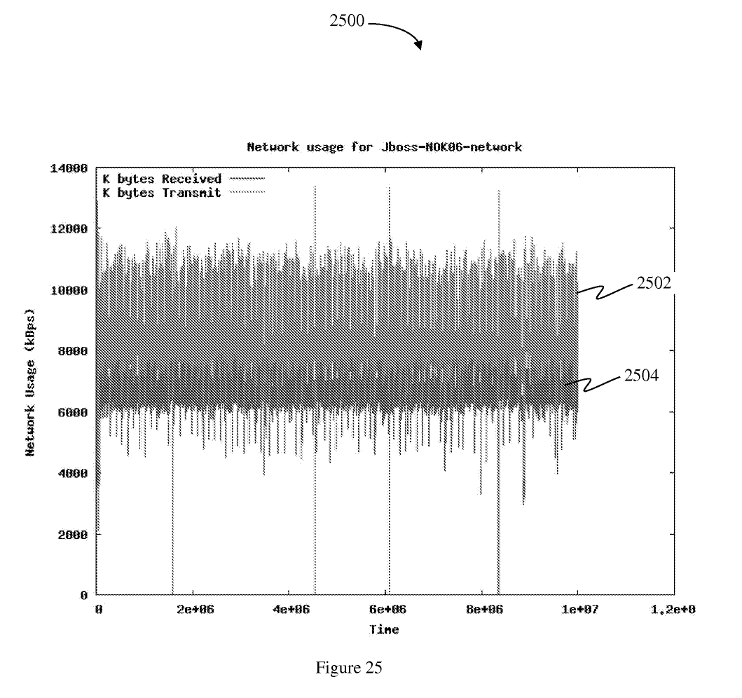

Referring now to FIG. 25, there is shown a chart of network usage bandwidth for an application server 2500 of the system 200. Similar to the data in FIG. 24, the amount of data transmitted 2502 by the application servers will be larger than the amount of data requests received 2504.

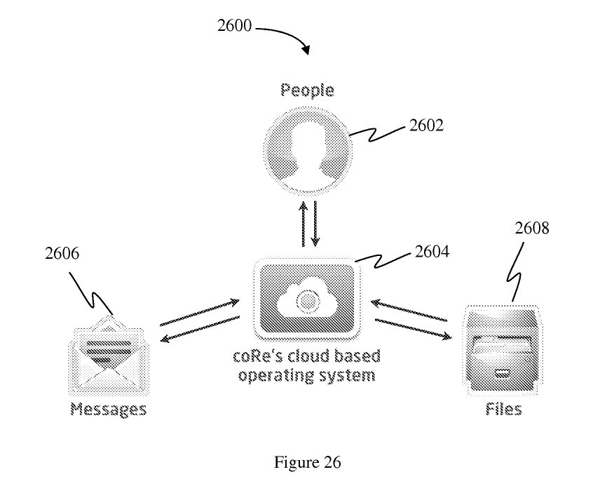

Referring now to FIG. 26, there is shown a workflow diagram 2600 of a mobile device where the content of the device is automatically updated contextually using the system 200. The smart phone platform 2602 is significantly smaller than a computer or a tablet. Therefore, the interface needs to be adjusted to enable all the functionality of the other devices. The user enters a request on their smart phone 2602. Next, the request is sent to the core system 2604. Then, the appropriate data 2606 and 2608 is accessed and the information is reformatted and sent back to the user 2602.

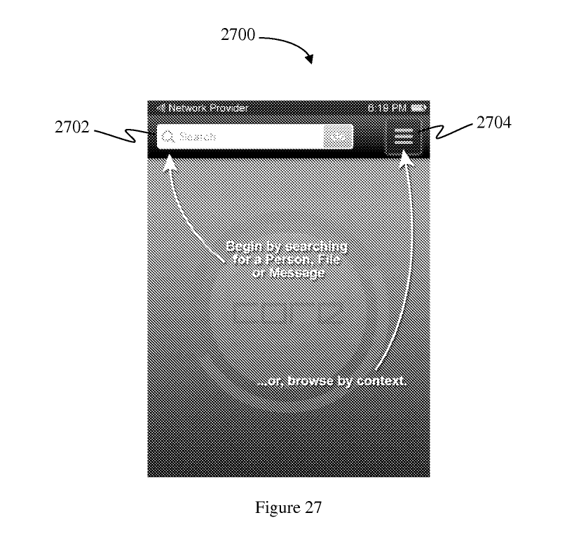

Referring now to FIG. 27, there is shown a search interface 2700 for accessing the content of the mobile device using the system 200, according to one embodiment. In this embodiment, the core system interface 2700 is represented by a simple search bar 2702, or a contextual browser 2704. The user can search for a person, file or message from the search bar 2702 without specific content. Alternatively, the user can select the contextual browser 2704 and search for the content by type.

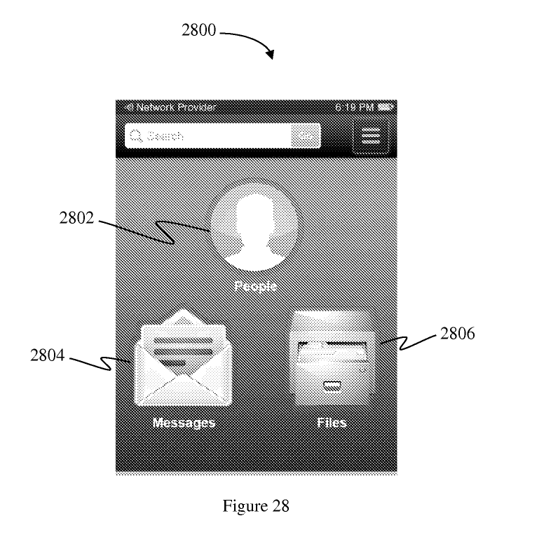

Referring now to FIG. 28, there is shown a diagram of a contextual browser interface 2800 for the mobile device using the system 200. As can be seen, the user can easily select the type of contextual information 2802, 2804 and 2806 that they are searching for using the contextual browser by selecting the appropriate icon. In one embodiment the contextual browser comprises people, messages and files 2802, 2804 and 2806.

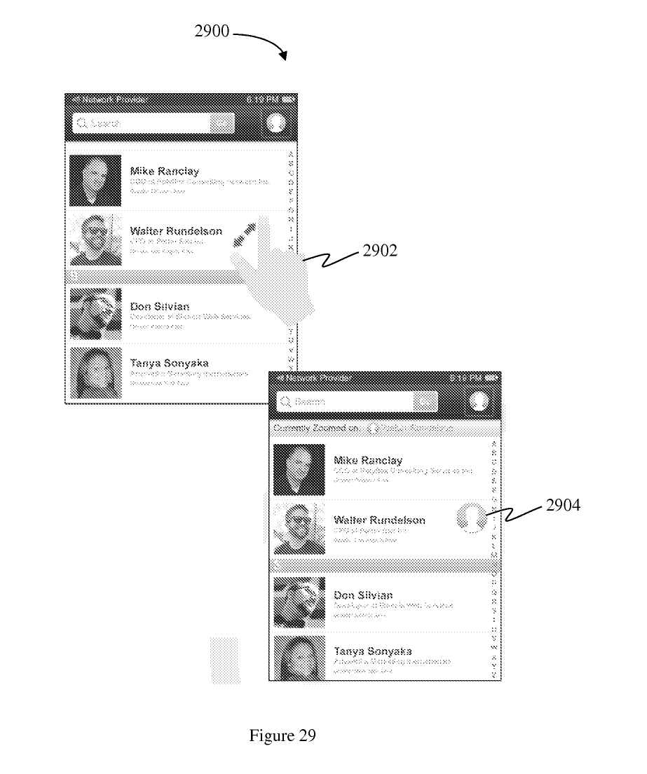

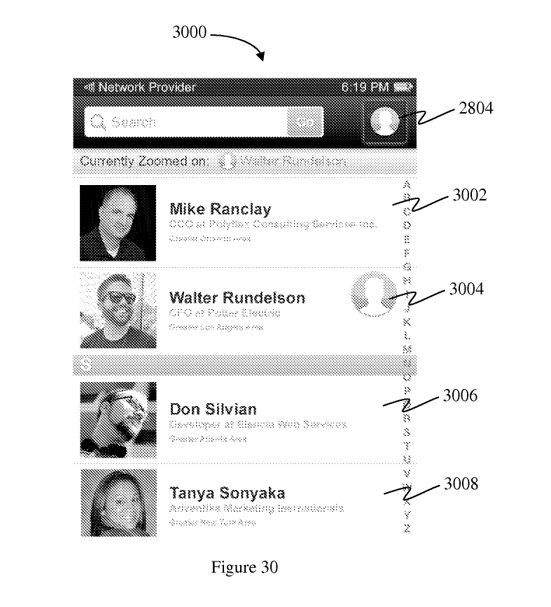

Referring now to FIGS. 29 and 30, there is shown a screenshot 2900 and 3000 of a selected content from the contextual browser interface 2800. In this example, the user has selected people 2802 to contextually search. Each of the users 3002, 3004, 3006 and 3008 are shown in any order, in this case the order is alphabetic. Once, the user has found the desired contact, the user can expand the listing by a pinch gesture 2902. Then, the contact is expanded to fill the screen with all the information related to the selected contact. Alternatively, the user can tag a contact 3002, 3004, 3006 and 3008, as is shown in the lower portion 2904 of the figure, so that the user can link multiple contacts 3002, 3004, 3006 and 3008 together, to send a single document or email to contextually related contacts.

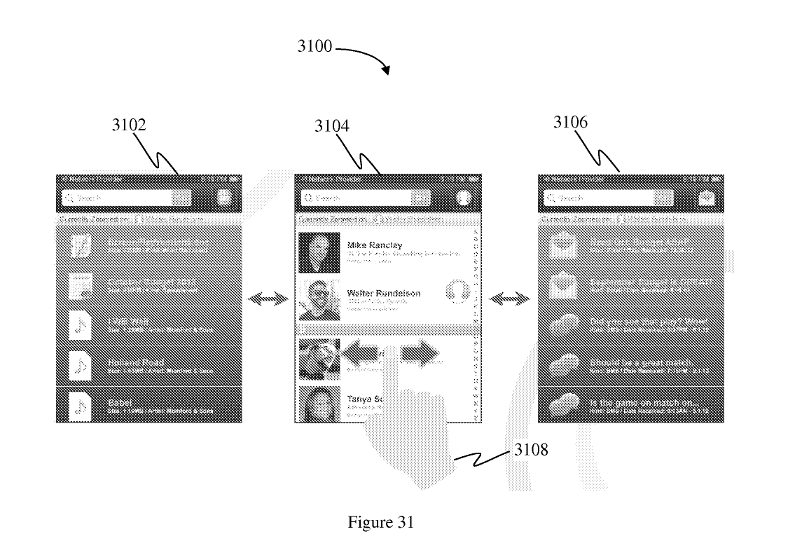

Referring now to FIG. 31, there is shown a diagram 3100 of a user motion 3108 for accessing content related to the selected contact 3404 from the contextual browser interface 2800. As was the case with the computer or tablet, the user can gesture left or right 3108 to access specific content related to the selected contact 3404, or a different contact. If the user selects a different contact, the tagged contact 2802 can have the related content associated with their contact information. This increase in efficiency over current applications has obvious benefits for single threaded devices that are limited in the number of applications that can be multi-tasked with limited computing power on the smart phone.

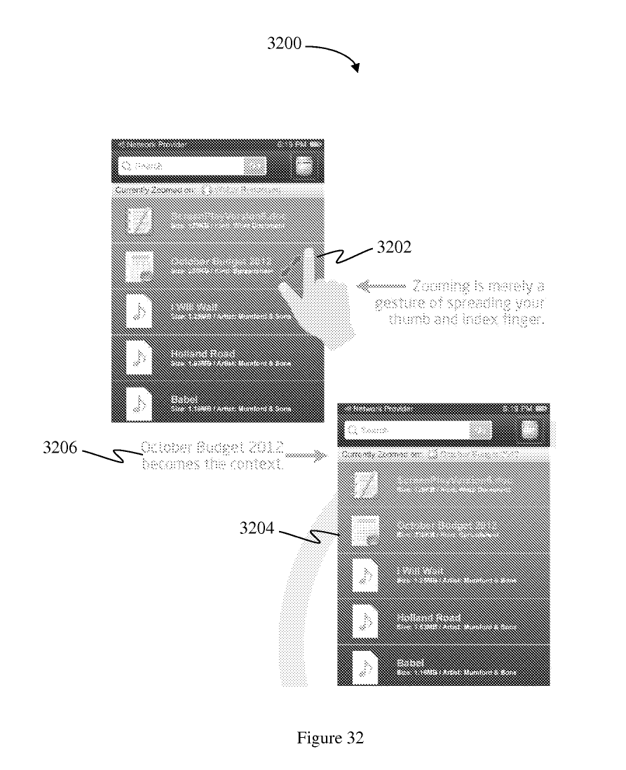

Referring now to FIG. 32, there is shown a diagram 3200 of a user motion for zooming 3202 on the content accessed in FIG. 31. As is shown, by using a zooming pinch gesture 3202, the user can shift the context to a particular document 3204. The shift in context is displayed to the user in a status bar 3206.

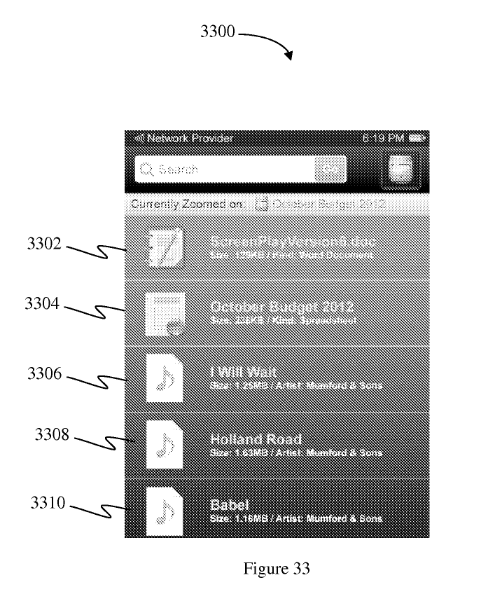

Referring now to FIG. 33, there is shown a diagram 3300 of content that is contextually related 3302, 3304, 3306, 3308 and 3310 to the content accessed in FIG. 32. The component parts of the selected zoomed content 3302, 3304, 3306, 3308 and 3310 are displayed for the user to manipulate.

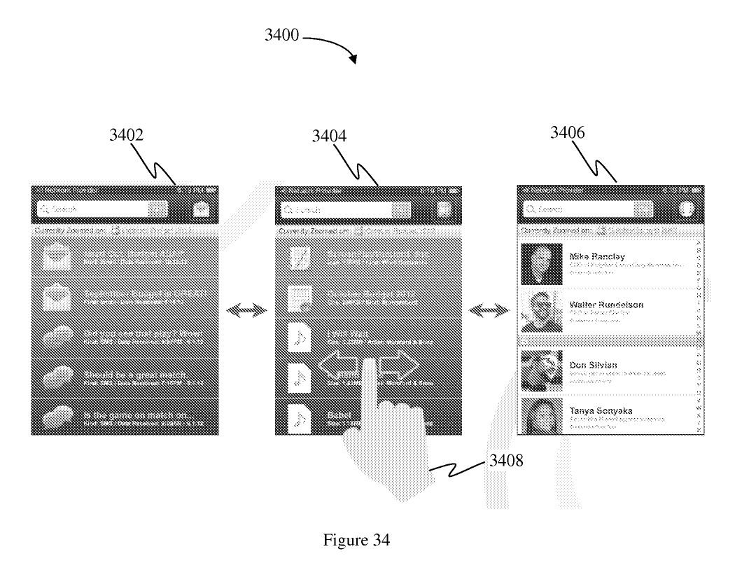

Referring now to FIG. 34, there is shown a diagram 3400 of a user motion 3408 for accessing related content 3402, 3406 and 3408 to the content accessed in FIG. 33. The user can also quickly see what other items are contextually related to the selected zoomed document, such as, for example, contacts, messages, email or chat.

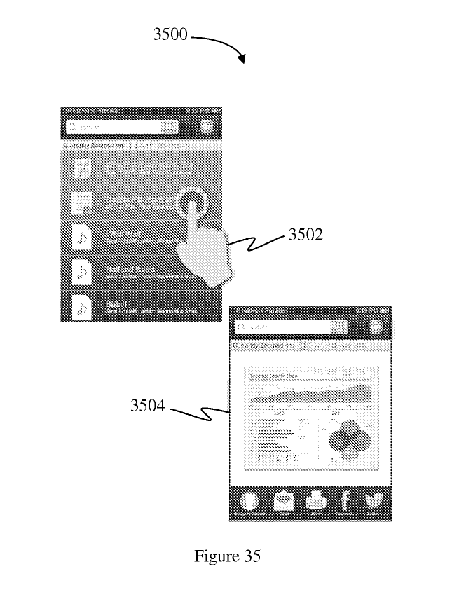

Referring now to FIG. 35, there is shown a diagram 3500 of the user motion 3505 for displaying the content accessed in FIG. 34. Tapping on the document 3502 opens the document 3504 on the user's device. The document 3504 is then displayed.

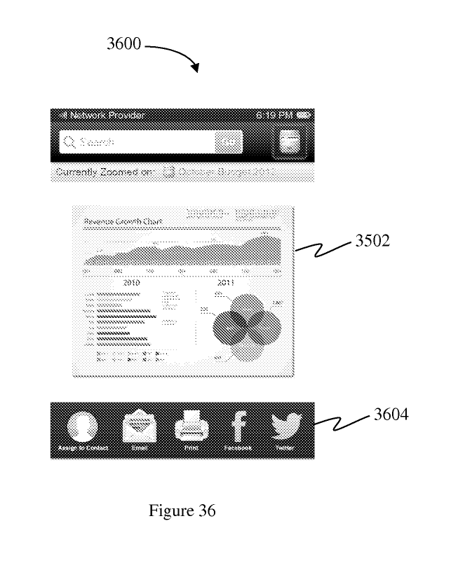

Referring now to FIG. 36, there is shown an enlarged view 3600 of the displayed content 3502 of FIG. 35. In this embodiment, the user can use the search bar 2702 to search within the opened document 3502. As can be appreciated, the search bar 2702 is contextual, that is, the function of the search bar 2702 is related to the content selected 3502. Therefore, the search bar 2702 can universally search all the data stored in the device, or simply search for words in an open document. This multi-purpose search bar 2702 simplifies the user's device and increases the efficiency of smart phone use.

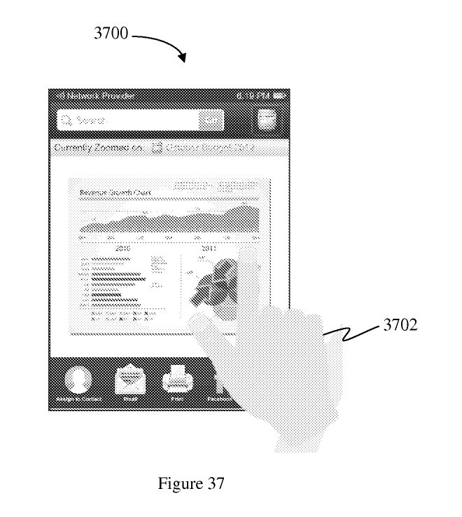

Referring now to FIG. 37, there is shown a diagram 3700 of a user motion 3702 for enlarging the displayed content 3502. By performing this gesture 3702, the user can zoom in on selected portions of the document 3502.

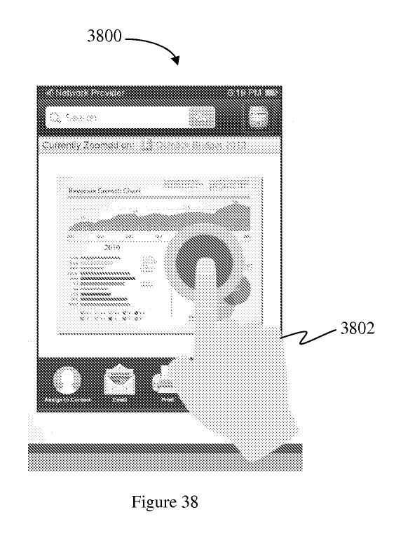

Referring now to FIG. 38, there is shown a diagram 3800 of a user motion 3802 for accessing all the information related to the area that the user selected with the user motion. The user can also select elements of the document for editing or manipulation to alter or update the document.

A more detailed reference of the operation and coding of the system and subsystems can be found in Appendix A that is hereby incorporated by reference in its entirety.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A system for server-side database-driven services that can be accessed by a variety of client side applications, the system comprising:
a) at least one proxy server;
b) at least one load balancer communicatively coupled to the at least one proxy server;
c) at least one web server communicatively coupled to the at least one proxy server;
d) at least one application server communicatively coupled to the at least one web server;
e) at least one database server communicatively coupled to the at least one application server;
f) at least one network aware file system communicatively coupled to the at least one application server,
where the proxy server, web server, application server, database server and network aware file system comprise a private cloud computing space for a user;
g) a user interface for accessing one or more than one interoperable client side applications communicatively coupled to the at least one application server; and
h) at least one server-side database-driven service module accessible by the one or more than one interoperable client side applications communicatively coupled to the at least one database server,
where the user can switch between the one or more than one client side applications without having to stop and start other client side applications.

2. The system of claim 1, where the at least one database server comprises a single integrated database with pre-defined links.

3. The system of claim 1 further comprising one or more than one data server.

4. The system of claim 3, where the one or more than one data server can comprise a file server, a streaming multimedia server, an application server or server cluster, a mail server and a chat server.

5. The system of claim 1, at least one network aware file system communicatively coupled to the at least one application server, where the proxy server, web server, application server, database server and network aware file system comprise a private cloud computing space for a user.

6. The system of claim 1, where the one or more than one interoperable client side applications can comprise a movies application, a calendar application, a document application, an e-mail application, a video application and a contacts application.

7. The system of claim 1, where the at least one database-driven service module can be accessed through the user interface that ties all the one or more than one client side applications together that comprises instructions operable on the at least one application server to provide an automatic contextual basis for accessing content.

8. The system of claim 1, where the user interface comprises a touch interface.

9. The system of claim 8, where the user interface is accessed by specific motions to quickly access the system.

10. The system of claim 9, where the specific motions comprise an up swipe, a right swipe, a left swipe and a downward swipe.

11. The system of claim 10, where the up swipe accesses a communications client side application, the right swipe access a file client side application, the left swipe accesses an events client side application, and the downward swipe accesses a contacts client side application.

12. The system of claim 8, where the user interface further comprises a help icon, where the help icon activates instructions for a client side application to access all contextually associated related data to an open client side application.

13. A method for using server-side database-driven services that can be accessed by a variety of client side applications, the method comprising the steps of:
a) providing the system of claim 1;
b) displaying a user interface;
c) accessing a user profile;
d) determining a user motion to access one or more than one interoperable client side applications;
e) receiving one or more than one request from the one or more than one interoperable client side applications;
f) executing instructions in the system corresponding to the received request from the user motion and the user profile;
f) accessing contextual data related to the received request and the user profile;
g) transmitting the contextual data to the one or more than one interoperable client side applications; and
h) storing in a database relations between the contextual data transmitted and the one or more than one interoperable client side applications and the user profile.

14. The method of claim 13, where the contextual data can comprise personal information, a document, a file, an e-mail and a calendar event.

15. The method of claim 13, where the one or more than one interoperable client side applications can display additional options where the user can add selected contextually related documents and files in one or more than one of the interoperable client side applications.

16. A method for using server-side database-driven services that can be accessed by a variety of client side applications, the method comprising the steps of:
a) accessing a user profile;
b) receiving requests from a plurality of client side applications;
c) determining a user traffic load over one or more than one database server;
d) balancing the user traffic load over one or more than one database server and one or more than one application server;
e) determining if additional application and database servers need to be dynamically added if the load of all the servers increases to a point that would impede the use of the system;
f) transmitting the requested data to the one or more than one client side application; and
g) storing relations between the transmitted data and the user profile.
